(19) United States
(12) Patent Application Publication
(10) Pub. No.: US 2009/0075133 A1
(43) Pub. Date: Mar. 19, 2009

(54) ELECTRODE FOR FUEL CELL, MEMBRANE-ELECTRODE ASSEMBLY FOR FUEL CELL, AND FUEL CELL SYSTEM INCLUDING SAME

(75) Inventors: Min-Kyu Song, Suwon-si (KR); Ji-Seok Hwang, Suwon-si (KR); In-Seob Song, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/209,069

(22) Filed: Sep. 11, 2008

(30) Foreign Application Priority Data
Sep. 19, 2007 (KR) 10-2007-0095314

(51) Int. Cl. H01M 8/18; H01M 4/00

(52) U.S. Cl. 429/19; 429/40

(57) ABSTRACT

Provided are an electrode and a membrane-electrode assembly for a fuel cell, and a fuel cell system including the same. The electrode for a fuel cell may include an electrode substrate and a catalyst layer disposed on one side of the electrode substrate. The electrode substrate may include a non-woven fabric or a woven fabric coated with an electrically conductive polymer. The electrode for a fuel cell may be configured for high-performance by promoting transfer of electrons, reactants and products.

### CROSS-REFERENCE TO RELATED APPLICATIONS

This application is a non-provisional application, which claims priority to and the benefit of Korean Patent Application No. 10-2007-0095314 filed in the Korean Intellectual Property Office on Sep. 19, 2007, the entire content of which is hereby incorporated by reference.

### BACKGROUND

1. Field of the Invention

The present invention relates to an electrode for a fuel cell, and a membrane-electrode assembly and a fuel cell system including the same. More particularly, the present invention relates to an electrode for a fuel cell that promotes electron transfer and transfer of reactants and products, and a membrane-electrode assembly and a fuel cell system including the same.

2. Description of the Related Art

Some types of fuel cells produce electrical energy through an electrochemical redox reaction of an oxidant and a fuel such as hydrogen, or a hydrocarbon-based material such as methanol, ethanol, natural gas, and the like. Such a fuel cell is a clean energy source that can replace fossil fuels. It includes a stack composed of unit cells and produces various ranges of power output. Since it has four to ten times higher energy density than a small lithium battery, it has been high-lighted as a small portable power source.

Representative exemplary fuel cells include a polymer electrolyte membrane fuel cell (PEMFC) and a direct oxidation fuel cell (DOFC). The direct oxidation fuel cell includes a direct methanol fuel cell that uses methanol as a fuel. The polymer electrolyte fuel cell has an advantage of high energy density and high power, but also has problems in the need to carefully handle hydrogen gas and the requirement of accessory facilities such as a fuel reforming processor for reforming methane or methanol, natural gas, and the like in order to produce hydrogen as the fuel gas. On the contrary, a direct oxidation fuel cell has lower energy density and power than that of the gas-type fuel cell and needs a large amount of catalysts. However, it has the advantages of easy handling of the liquid-type fuel, a low operation temperature, and no need for additional fuel reforming processors.

### SUMMARY OF CERTAIN INVENTIVE ASPECTS

In one aspect an electrode for a fuel cell promotes electron transfer and transfer of reactants and products.

In another aspect an electrode for a fuel cell comprises an electrode substrate and a catalyst layer disposed on one side of the electrode substrate. In some embodiments the electrode substrate comprises a non-woven fabric coated with an electrically conductive polymer or a woven fabric coated with an electrically conductive polymer.

In some embodiments the electrically conductive polymer is selected from the group consisting of polyaniline, polypyrrol, polyacetylene, polyacene, polythiophene, polyalkylthiophene, poly(p-phenylene), polyphenylene, polyphenylenesulfide, polyphenylenevinylene and polyfuran. In some embodiments the electrically conductive polymer comprises about 1 to about 30 wt % based on the total weight of the electrode substrate. In some embodiments the electrically conductive polymer comprises about 5 to about 20 wt % based on the total weight of the electrode substrate. In some embodiments the non-woven fabric or the woven fabric comprises a material selected from the group consisting of a polymer and glass fiber. In some embodiments the electrically conductive polymer is selected from the group consisting of a polyolefin-based polymer, a polyester-based polymer, a polysulfone-based polymer, a polyimide-based polymer, a polyetherimide-based polymer, a polyamide-based polymer, polyalkylene and rayon. In some embodiments the electrically conductive polymer is selected from the group consisting of polyethyleneterephthalate (PET) and polybutyleneterephthalate (PBT).

In some embodiments the electrode substrate includes macropores and micropores, wherein a macropore diameter is “A” and a micropore diameter is “a”, and wherein A−a≦2.5 μm. In some embodiments the macropores have an average pore diameter ranging from about 0.5 μm to about 3.0 μm. In some embodiments the macropores have an average pore diameter ranging from about 0.5 μm to about 2.0 μm. In some embodiments the micropores have an average pore diameter ranging from about 0.01 μm to about 0.5 μm. In some embodiments the micropores have an average pore diameter ranging from about 0.02 μm to about 0.3 μm. In some embodiments the electrode substrate has a tensile strength ranging from about 5 kg/mm² to about 50 kg/mm². In some embodiments the electrode substrate has a tensile strength ranging from about 20 kg/mm² to about 30 kg/mm².

In some embodiments the electrode substrate further comprises a microporous layer, the microporous layer including fluorinated resin or a conductive powder. In some embodiments the conductive powder is selected from the group consisting of carbon powder, carbon black, acetylene black, activated carbon, carbon fiber, fullerene, carbon nanotubes, carbon nanowire, carbon nanohorns and carbon nanorings. In some embodiments the fluorinated resin is selected from the group consisting of polyvinylidene fluoride, polytetrafluoroethylene, fluorinated ethylenepropylene, polychlorotrifluoroethylene and fluoroethylene polymer.

In another aspect a membrane-electrode assembly for a fuel cell comprises an anode and a cathode facing each other and a polymer electrolyte membrane disposed between the anode and the cathode. In some embodiments at least one of the anode and the cathode comprises an electrode substrate and a catalyst layer disposed on one side of the electrode substrate, wherein the electrode substrate comprises a non-woven fabric coated with an electrically conductive polymer or a woven fabric coated with an electrically conductive polymer.

In some embodiments the electrically conductive polymer is selected from the group consisting of polyaniline, polypyrrol, polyacetylene, polyacene, polythiophene, polyalkylthiophene, poly(p-phenylene), polyphenylene, polyphenylenesulfide, polyphenylenevinylene and polyfuran. In some embodiments the electrically conductive polymer comprises an amount ranging from about 1 to about 30 wt % based on the total weight of the electrode substrate. In some embodiments the electrically conductive polymer comprises an amount ranging from about 5 to about 20 wt % based on the total weight of the electrode substrate.

In some embodiments the non-woven fabric or the woven fabric comprises a material selected from the group consisting of a polymer and glass fiber. In some embodiments the polymer is selected from the group consisting of a polyolefin-based polymer, a polyester-based polymer, a polysulfone-based polymer, a polyimide-based polymer, a polyetherimide-based polymer, a polyamide-based polymer, polyalkylene and rayon. In some embodiments the polymer is selected from the group consisting of polyethyleneterephthalate (PET) and polybutyleneterephthalate (PBT).

In some embodiments the electrode substrate comprises macropores and micropores, wherein a macropore diameter is “A”, wherein a micropore diameter is “a”, and wherein A−a≦2.5 μm. In some embodiments the macropores have an average pore diameter ranging from about 0.5 μm to about 3.0 μm. In some embodiments the macropores have an average pore diameter ranging from about 0.5 μm to about 2.0 μm. In some embodiments the micropores have an average pore diameter ranging from about 0.01 μm to about 0.5 μm. In some embodiments the micropores have an average pore diameter ranging from about 0.02 μm to about 0.3 μm. In some embodiments the electrode substrate has a tensile strength ranging from about 5 kg/mm² to about 50 kg/mm². In some embodiments the electrode substrate has a tensile strength ranging from about 20 kg/mm² to about 30 kg/mm².

In some embodiments the electrode substrate further comprises a microporous layer, the microporous layer including fluorinated resin or a conductive powder. In some embodiments the conductive powder is selected from the group consisting of carbon powder, carbon black, acetylene black, activated carbon, carbon fiber, fullerene, carbon nanotubes, carbon nanowire, carbon nanohorns and carbon nanorings. In some embodiments the fluorinated resin is selected from the group consisting of polyvinylidene fluoride, polytetrafluoroethylene, fluorinated ethylenepropylene, polychlorotrifluoroethylene and a fluoroethylene polymer.

In another aspect fuel cell system comprises an electricity generating element comprising a membrane-electrode assembly, the membrane-electrode assembly comprising an anode and a cathode disposed opposite to each other, a polymer electrolyte membrane, and separators, wherein the electricity generating element is configured to generate electricity based on oxidation of a fuel and reduction of an oxidant, a fuel supplier configured to supply the fuel to the electricity generating element and an oxidant supplier configured to supply the oxidant to the electricity generating element. In some embodiments at least one of the anode and the cathode comprises an electrode substrate and a catalyst layer disposed on one side of the electrode substrate, and wherein the electrode substrate comprises a non-woven fabric coated with an electrically conductive polymer and a woven fabric coated with an electrically conductive polymer.

In some embodiments the electrically conductive polymer is selected from the group consisting of polyaniline, polypyrrol, polyacetylene, polyacene, polythiophene, polyalkylthiophene, poly(p-phenylene), polyphenylene, polyphenylenesulfide, polyphenylenevinylene and polyfuran. In some embodiments the electrically conductive polymer comprises an amount of about 1 to about 30 wt % based on the total weight of the electrode substrate. In some embodiments the electrically conductive polymer comprises an amount of about 5 to about 20 wt % based on the total weight of the electrode substrate. In some embodiments the non-woven fabric or the woven fabric comprise a material selected from the group consisting of a polymer and glass fiber. In some embodiments the polymer is selected from the group consisting of a polyolefin-based polymer, a polyester-based polymer, a polysulfone-based polymer, a polyimide-based polymer, a polyetherimide-based polymer, a polyamide-based polymer, polyalkylene and rayon. In some embodiments the polymer is selected from the group consisting of polyethyleneterephthalate (PET) and polybutyleneterephthalate (PBT).

In some embodiments the electrode substrate includes macropores and micropores, wherein a macropore diameter is “A”, wherein a micropore diameter is “a”, and wherein A−a≦2.5 μm. In some embodiments the macropores have an average pore diameter ranging from about 0.5 μm to about 3.0 μm. In some embodiments the macropores have an average pore diameter ranging from about 0.5 μm to about 2.0 μm. In some embodiments the micropores have an average pore diameter ranging from about 0.01 μm to about 0.5 μm. In some embodiments the micropores have an average pore diameter ranging from about 0.02 μm to about 0.3 μm. In some embodiments the electrode substrate has a tensile strength ranging from about 5 kg/mm² to about 50 kg/mm². In some embodiments the electrode substrate has a tensile strength ranging from about 20 kg/mm² to about 30 kg/mm².

In some embodiments the electrode substrate further comprises a microporous layer, the microporous layer including a fluorinated resin or a conductive powder. In some embodiments the conductive powder is selected from the group consisting of carbon powder, carbon black, acetylene black, activated carbon, carbon fiber, fullerene, carbon nanotubes, carbon nanowire, carbon nanohorns and carbon nanorings. In some embodiments the fluorinated resin is selected from the group consisting of polyvinylidene fluoride, polytetrafluoroethylene, fluorinated ethylenepropylene, polychlorotrifluoroethylene and fluoroethylene polymer.

### BRIEF DESCRIPTION OF THE DRAWINGS

An apparatus according to some of the described embodiments can have several aspects, no single one of which necessarily is solely responsible for the desirable attributes of the apparatus. After considering this discussion, and particularly after reading the section entitled “Detailed Description” one will understand how the features of this invention provide advantages that include the ability to make and use a membrane electrode assembly for a fuel cell, and a fuel cell system including the same.

FIG. 1 is a schematic view of a membrane-electrode assembly according to one embodiment of the present invention.

FIG. 2 is a schematic view of a fuel cell system according to one embodiment of the present invention.

FIG. 3 is a graph showing output density of single cells according to Examples 1, 5, and 6, and Comparative Example 1.

### DETAILED DESCRIPTION OF CERTAIN INVENTIVE EMBODIMENTS

As will be appreciated, the following detailed description is directed to certain specific embodiments of the invention. However, the invention can be embodied in a multitude of different ways. The present invention relates to an electrode for a fuel cell, and particularly to an electrode substrate. The electrode substrate supports a catalyst layer, supplies fuel and oxidant to the catalyst layer after diffusion and partly performs a role of collecting a current generated in the catalyst layer and transferring it to separators.

Thus, in some embodiments an electrode substrate is configured to easily let the fuel and the oxidant in, discharge reaction products and have high electrical conductivity. Generally, the electrode substrate comprises a conductive material such as carbon paper after water repellent treatment with a fluorine resin such as polytetrafluoroethylene. In some embodiments the electrode substrate comprising carbon paper has diverse pore sizes. In some embodiments the carbon paper includes micropores. Thus, when water, which is a reaction product, is precipitated on the micropores, it is difficult to remove with an air influx during conditions of general battery operation. The precipitated water increases material transferring resistance of a reactant and thereby deteriorates the battery performance. Also, since carbon paper is expensive and has weak mechanical strength, it is hard to produce electrode substrates in mass. Thus, some embodiments of the present disclosure provide an electrode for a fuel cell that can resolve the above problems.

In one embodiment the electrode for a fuel cell includes an electrode substrate and a catalyst layer disposed on one side of the electrode substrate. The electrode substrate includes a non-woven fabric or a woven fabric coated with an electrically conductive polymer. In some embodiments the surface of the non-woven fabric or woven fabric is coated with the electrically conductive polymer. Examples of the electrically conductive polymer include, but are not limited to, at least one selected from the group consisting of polyaniline, polypyrrol, polyacetylene, polyacene, polythiophene, polyalkylthiophene, poly(p-phenylene), polyphenylene, polyphenylenesulfide, polyphenylenevinylene, polyfuran, and combinations thereof

In some embodiments the electrically conductive polymer is present in an amount of about 1 to about 30 wt % based on the total weight of the electrode substrate. In some embodiments of the present invention, the electrically conductive polymer is present in an amount of about 5 to about 20 wt % based on the total weight of the electrode substrate. When the amount of the electrically conductive polymer is less than about 1 wt %, it is not uniformly applied onto the surface of the non-woven fabric and thus electrical conductivity may be deteriorated. On the contrary, when the amount of the electrically conductive polymer is more than about 30 wt %, individual pores may be clogged.

In some embodiments the non-woven fabric or woven fabric is made of at least one material selected from the group consisting of a polymer, glass fiber, and combinations thereof The polymer may be selected from the group consisting of at least one selected from the group consisting of a polyolefin-based polymer, a polyester-based polymer, a polysulfone-based polymer, a polyimide-based polymer, a polyetherimide-based polymer, a polyamide-based polymer, C1 to C10 polyalkylene, rayon, and combinations thereof According to one embodiment of the present invention, a polymer selected from the group consisting of polyethyleneterephthalate (PET), polybutyleneterephthalate (PBT), and combinations thereof may be appropriate.

In some embodiments the electrode substrate includes both macropores and micropores. In some embodiments a pore diameter of the macropores “A” and a pore diameter “a” of the micropores satisfy the following: A−a≦2.5 μm. When A−a, which is the difference between the average pore diameter of the macropores and that of the micropores, exceeds 2.5 μm, the difference between the average pore diameter of the macropores and that of the micropores becomes too large, such that water, which is a reaction product, may be precipitated on the micropores. The precipitated water increases material transfer resistance of the electrode substrate and thereby deteriorates battery performance.

As described above, the difference between the average pore diameter of the macropores and that of the micropores formed in the electrode substrate can be reduced by the controlling function of the pore structure, in which non-woven fabric or woven fabric is coated with an electrically conductive polymer.

In some embodiments the electrode substrate includes macropores having an average diameter ranging from about 0.5 μm to about 3.0 μm. According to one embodiment the electrode substrate includes macropores having an average diameter ranging from about 0.5 μm to about 2.0 μm. The electrode substrate includes micropores having an average diameter ranging from about 0.01 μm to about 0.5 μm. According to one embodiment the electrode substrate includes micropores having an average diameter ranging from about 0.02 μm to about 0.3 μm. When the difference between average macropore diameter and average micropore diameter is within the range, reactants such as the fuel and the oxidant, and the reaction product, which is water, can be removed without difficulty.

In some embodiments the electrode substrate has a tensile strength ranging from about 5 kg/mm² to about 50 kg/mm². According to one embodiment of the present invention, the electrode substrate has a tensile strength ranging from about 20 kg/mm² to about 30 kg/mm². When the tensile strength of the electrode substrate is within the range, it is possible to produce the MEA based on a typical roll-to-roll method and perform a stack assembly process continuously. Thus, there is an advantage that productivity is improved. When the tensile strength is out of the range, the manufacturing process may be inconsistent, which is undesirable.

In some embodiments the electrode substrate includes a microporous layer, the microporous layer including a fluorinated resin and/or a conductive powder. Examples of the fluorinated resin include at least one selected from the group consisting of polyvinylidene fluoride, polytetrafluoroethylene, fluorinated ethylenepropylene, polychlorotrifluoroethylene, a fluoroethylene polymer, and combinations thereof

Examples of the conductive powder include at least one selected from the group consisting of carbon powder, carbon black, acetylene black, activated carbon, carbon fiber, fullerene, carbon nanotubes, carbon nanowire, carbon nanohorns, carbon nanorings, and combinations thereof The conductive powder and the fluorinated resin may be included in the microporous layer at a weight ratio of about 99:1 to about 50:50, and more specifically, at a weight ratio of about 99:1 to about 70:30, and even more specifically, at a weight ratio of about 88:12 to about 73:27. When the contents of the conductive powder and the fluorinated resin in the microporous layer are within the range, flooding can be suppressed, which is desirable. When they are out of the range, the conductivity is deteriorated, which is not desirable.

In some embodiments the electrode substrate comprises an electrically conductive polymer, which has electrical conductivity, can easily supply the reactant, i.e., provide the fuel and the oxidant, and can discharge the reaction product, i.e., water; the electrode substrate may be configured to function similar to the conventional microporous layer. Thus, in some embodiments of an electrode substrate an additional microporous layer is optional.

In some embodiments a catalyst layer is disposed on one side of the electrode substrate. The catalyst layer includes a catalyst. The catalyst may be any catalyst that can perform a fuel cell reaction. In some embodiments the catalyst includes a platinum-based catalyst. The platinum-based catalysts includes platinum, ruthenium, osmium, a platinum-ruthenium alloy, a platinum-osmium alloy, a platinum-palladium alloy, a platinum-M alloy, or combinations thereof, where M is a transition element selected from the group consisting of Ga, Ti, V, Cr, Mn, Fe, Co, Ni, Cu, Zn, Sn, Mo, W, Rh, Ru, and combinations thereof Representative examples of the catalysts include at least one selected from the group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, and combinations thereof.

In some embodiments the catalyst is used in a form of a metal itself (black catalyst), or while being supported on a carrier. In some embodiments the carrier includes a carbon-based material such as graphite, denka black, ketjen black, acetylene black, carbon nanotubes, carbon nanofiber, carbon nanowire, carbon nanoballs, activated carbon, and so on, or an inorganic particulate such as alumina, silica, zirconia, titania, and so on. Other types of carbon-based material are generally known in the art.

In some embodiments the catalyst layer includes a binder resin to improve adherence and proton transfer properties. The binder resin may be a proton conductive polymer resin having a cation exchange group selected from the group consisting of a sulfonic acid group, a carboxylic acid group, a phosphoric acid group, a phosphonic acid group, and derivatives thereof at its side chain. Non-limiting examples of the polymer include at least one proton conductive polymer selected from the group consisting of perfluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly(2,5-benzimidazole).

The binder resins may be used singularly or in combination. They may be used along with non-conductive polymers to improve adherence with a polymer electrolyte membrane. The binder resins may be used in a controlled amount to adapt to their purposes. Non-limiting examples of the non-conductive polymers include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE), chlorotrifluoroethylene-ethylene copolymers (ECTFE), polyvinylidene fluoride, polyvinylidene fluoride-hexafluoropropylene copolymers (PVdF-HFP), dodecylbenzenesulfonic acid, sorbitol, and combinations thereof

In some embodiments the electrode having one of the above-described structures can be coupled to an anode or a cathode. In some embodiments a membrane-electrode assembly includes an anode and a cathode, and a polymer electrolyte membrane interposed between the cathode and the anode. At least one of the anode and the cathode may have one of the electrode structures described above.

In some embodiments the polymer electrolyte membrane is configured to function as an ion-exchange member to transfer protons generated in an anode catalyst layer of the cathode catalyst layer. In some embodiments the polymer electrolyte membrane of the membrane-electrode assembly includes a proton conductive polymer resin. In some embodiments the proton conductive polymer resin is a polymer resin having a cation exchange group selected from the group consisting of a sulfonic acid group, a carboxylic acid group, a phosphoric acid group, a phosphonic acid group, and derivatives thereof, at its side chain. Non-limiting examples of the polymer resin include at least one selected from the group consisting of fluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid) (NAFION™), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly(2,5-benzimidazole). The hydrogen (H) in the proton conductive group of the proton conductive polymer can be substituted with Na, K, Li, Cs, or tetrabutylammonium. When the H in the ionic exchange group of the terminal end of the proton conductive polymer side is substituted with Na or tetrabutylammonium, NaOH or tetrabutylammonium hydroxide may be used, respectively. When the H is substituted with K, Li, or Cs, suitable compounds for the substitutions may be used. Since such a substitution is known to this art, a detailed description thereof is omitted.

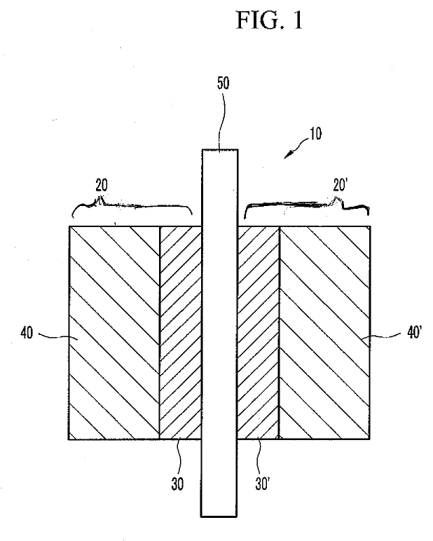

One embodiment of a membrane-electrode assembly 10 is schematically illustrated in FIG. 1. The membrane-electrode assembly 10 includes an anode 20 and a cathode 20′ facing each other, and a polymer electrolyte membrane 50 disposed between the anode 20 and the cathode 20′. The anode 20 includes an electrode substrate 40 having a structure similar to those embodiments described above and a catalyst layer 30 disposed on the electrode substrate 40. The cathode 20′ includes an electrode substrate 40′ having a structure similar to those embodiments described above and a catalyst layer 30′ disposed on the electrode substrate 40′.

In some embodiments the membrane-electrode assembly comprises an electrode substrate with a non-woven fabric or a woven fabric coated with a composition that includes an electrically conductive polymer, disposing a catalyst layer on the electrode substrate and assembling the electrode substrate and a polymer electrolyte membrane. In some embodiments the non-woven fabric or woven fabric is coated with a composition that includes an electrically conductive polymer. In some embodiments the non-woven fabric or woven fabric comprises at least one material selected from the group consisting of a polymer, glass fiber, and combinations thereof In some embodiments the non-woven fabric or woven fabric is subjected to plasma or electron beam treatment to form roughness on the surface thereof.

In some embodiments the composition, which includes an electrically conductive polymer, can be prepared by dissolving an electrically conductive polymer and an organic acid in a solvent. Examples of the electrically conductive polymer include, but are not limited to, at least one selected from the group consisting of polyaniline, polypyrrol, polyacetylene, polyacene, polythiophene, polyalkylthiophene, poly(p-phenylene), polyphenylene, polyphenylenesulfide, polyphenylenevinylene, polyfuran, and combinations thereof The organic acid acts as an oxidant that oxidizes a polymer chain and also dopes an anion to endow a polymer with electrical conductivity. Examples of the organic acid include substituted or unsubstituted sulfonic acid. More specific examples of the organic acid include at least one selected from the group consisting of camphorsulfonic acid, dodecylbenzenesulfonic acid, benzenesulfonic acid, toluenesulfonic acid, butylbenzenesulfonic acid, octylbenzenesulfonic acid, and combinations thereof Examples of the solvent include water, an organic solvent, and a mixed solvent thereof More specific examples of the solvent include an alcohol such as methanol and ethanol, and isopropanol, hexane, chloroform, tetrahydrofuran, ether, methylene chloride, acetone, acetonitrile, N-methyl pyrrolidone, and so on. According to one embodiment, N-methyl pyrrolidone may be appropriately used.

In some embodiments the electrically conductive polymer and organic acid are used in a mole ratio of about 1:1 to about 15:1. In one embodiment the electrically conductive polymer and organic acid are used in a mole ratio of about 5:5 to about 15:5. When within the range of the above mole ratios, the synthesized polymer has an average molecular weight such that it can be dissolved in an organic solvent while maintaining conductivity. When the mole ratio is outside of the above-listed range, a polymer chain length is shortened, and thus either conductivity is reduced or a molecular weight of the polymer is excessively increased so that the polymer is not dissolved in the organic solvent. Examples of the electrically conductive polymer include at least one selected from the group consisting of polyolefin-based polymers, polyester-based polymers, polysulfone-based polymers, polyimide-based polymers, polyetherimide-based polymers, polyamide-based polymers, polyalkylene, rayon, and copolymers thereof.

In some embodiments the composition including an electrically conductive polymer is coated using a general impregnation method or a coating method. Examples of the coating method include screen printing, spray coating, coating with a doctor blade, gravure coating, dip coating, a silk screen method, painting, and the like, but are not limited thereto. According to one embodiment, impregnation method may be appropriate. Alternatively, a fluorinated resin and a conductive powder are dispersed in a solvent to prepare a microporous layer composition that can optionally be coated on an electrode substrate to form a microporous layer. The microporous layer can also be formed using a general method, and a detailed description thereof is not provided.

Subsequently, a catalyst layer may be formed on the fabricated electrode substrate. Then the resulting electrode substrate is assembled with a polymer electrolyte membrane to fabricate a membrane-electrode assembly. Alternatively, a catalyst layer is formed on a polymer electrolyte membrane and then the resulting polymer electrolyte membrane is assembled with the above electrode substrate to fabricate a membrane-electrode assembly.

In some embodiments the catalyst layer and polymer electrolyte membrane are the same as described above. Methods of forming a catalyst layer on an electrode substrate and methods of assembling a polymer electrolyte membrane and an electrode substrate are well known in this art and therefore detailed descriptions thereof are not provided.

In some embodiments the above fabricated membrane-electrode assembly includes an electrode substrate having a narrow pore size distribution, which can easily release reaction products such as water and carbon dioxide and that supplies a fuel or an oxidant while maintaining good electrical conductivity.

In some embodiments a fuel cell system including the above membrane-electrode assembly is provided. The fuel cell system includes at least one electricity generating element, a fuel supplier, and an oxidant supplier. The electricity generating element includes a membrane-electrode assembly and a separator. The membrane-electrode assembly includes a polymer electrolyte membrane, and a cathode and an anode disposed at opposite sides of the polymer electrolyte membrane. The electricity generating element generates electricity through oxidation of a fuel and reduction of an oxidant.

In some embodiments the fuel supplier is configured to supply the electricity generating element with a fuel. In some embodiments the oxidant supplier is configured to supply the electricity generating element with an oxidant such as oxygen or air. In some embodiments the fuel includes liquid or gaseous hydrogen, or a hydrocarbon-based fuel such as methanol, ethanol, propanol, butanol, and natural gas.

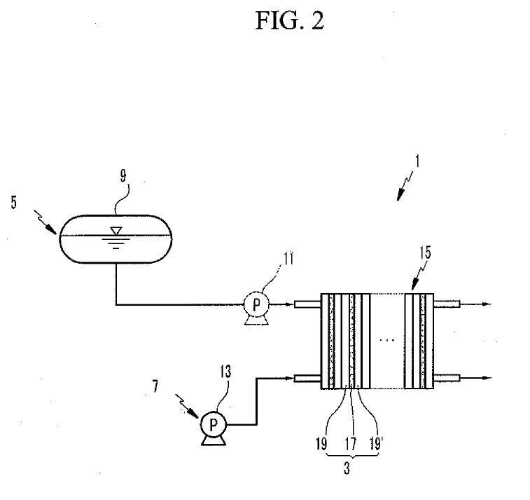

FIG. 2 shows a schematic structure of a fuel cell system 1 wherein a fuel and an oxidant are provided to the electricity generating element 3 through pumps. In some embodiments the fuel cell system alternatively includes a structure wherein a fuel and an oxidant are provided in a diffusion manner.

As illustrated in FIG. 2 the fuel cell system 1 includes at least one electricity generating element 3 configured to generate electrical energy through an electrochemical reaction of a fuel and an oxidant. The fuel cell system 1 also includes a fuel supplier 5 configured to supply fuel to the electricity generating element 3. Finally, the fuel cell system 1 includes an oxidant supplier 7 configured to supply an oxidant to the electricity generating element 3.

In addition, the fuel supplier 5 is equipped with a tank 9 configured to store fuel, and a fuel pump 11 that is connected therewith. The fuel pump 11 is configured to supply fuel stored in the tank 9 with a predetermined pumping power. The oxidant supplier 7, which supplies the electricity generating element 3 with an oxidant, is equipped with at least one pump 13 for supplying an oxidant with a predetermined pumping power. The electricity generating element 3 includes a membrane-electrode assembly 17 configured to both oxidize hydrogen or other fuel and also reduce an oxidant. The electricity generating element 3 further includes separators 19 and 19′ positioned at opposite sides of the membrane-electrode assembly 17 and supply hydrogen or a fuel, and an oxidant. At least one electricity generating element 3 is composed of a stack 15.

The following examples illustrate various embodiments of the present disclosure in more detail. It will be understood by one of skill in the art that the attached claims are not limited to any one or group of the embodiments illustrated in the following examples.

### EXAMPLE 1

An electrically conductive polymer composition was prepared by dissolving a 10 wt % polyaniline emeraldine base in an N-methylpyrrolidone solvent, and adding dodecylbenzenesulfonic acid to the solution. Herein, the organic acid was added at a molar ratio such that the ratio of the aniline monomer of the polyaniline emeraldine base to the organic acid=2:1.

An electrode substrate was fabricated by deep coating a commercial polyethyleneterephthalate non-woven fabric with the composition in a thickness of 250 μm, drying it at 100° C., and repeating the process ten times.

A composition for forming a catalyst layer was prepared by dripping 12 wt % of NAFION® produced by the Dupont company and 45 g of isopropyl alcohol onto 5.0 g of a Pt black (Hispec 1000, Johnson Matthey company) and Pt/Ru black (Hispec 6000, Johnson Matthey company) catalyst and mechanically agitating them.

The catalyst layer forming composition was directly applied to one side of a polymer electrolyte membrane (NAFION® 115, Dupont company) by a screen printing method. Herein, the area of the formed catalyst layer was 5×5 cm2, and the load amount of the catalyst was 6 mg/cm2. The other side of the polymer electrolyte membrane was coated in the same method to thereby form a catalyst layer of an anode and a cathode on both sides of the polymer electrolyte membrane.

A 25 cm2 single cell was fabricated by physically attaching the fabricated electrode substrates onto both sides of the polymer electrolyte membrane, interposing them between two pieces of gasket, interposing them between two separators where a flow channel and a cooling channel each having a predetermined shape were formed, and compressing them between copper end plates.

### EXAMPLE 2

A single cell was fabricated according to the same method as in Example 1, except that benzenesulfonic acid was used instead of the dodecylbenzenesulfonic acid.

### EXAMPLE 3

A single cell was fabricated according to the same method as in Example 1, except that toluenesulfonic acid was used instead of the dodecylbenzenesulfonic acid.

### EXAMPLE 4

A single cell was fabricated according to the same method as in Example 1, except that butylbenzenesulfonic acid was used instead of the dodecylbenzenesulfonic acid.

### EXAMPLE 5

A single cell was fabricated according to the same method as in Example 1, except that a polyester non-woven fabric was used instead of the polyethyleneterephthalate non-woven fabric.

### EXAMPLE 6

A single cell was fabricated according to the same method as in Example 1, except that the polyethyleneterephthalate was radiated with a 100 W microwave, and coated with the composition including an electrically conductive polymer.

### EXAMPLE 7

A single cell was fabricated according to the same method as in Example 1, except that polypyrrol was used instead of the polyaniline emeraldine base.

### EXAMPLE 8

A single cell was fabricated according to the same method as in Example 1, except that polyacetylene was used instead of the polyaniline emeraldine base.

### EXAMPLE 9

A single cell was fabricated according to the same method as in Example 1, except that polyacene was used instead of the polyaniline emeraldine base.

### EXAMPLE 10

A single cell was fabricated according to the same method as in Example 1, except that polythiophene was used instead of the polyaniline emeraldine base.

### EXAMPLE 11

A single cell was fabricated according to the same method as in Example 1, except that poly(p-phenylene) was used instead of the polyaniline emeraldine base.

### EXAMPLE 12

A single cell was fabricated according to the same method as in Example 1, except that polyphenylene was used instead of the polyaniline emeraldine base.

### EXAMPLE 13

A single cell was fabricated according to the same method as in Example 1, except that polyfuran was used instead of the polyaniline emeraldine base.

### COMPARATIVE EXAMPLE 1

A single cell was fabricated according to the same method as in Example 1, except that an electrode substrate was fabricated as follows: a commercial carbon paper (SGL Carbon Group Company, SGL 31AC) was impregnated with a water-repellent treatment composition including 5 g of polytetrafluoroethylene (PTFE) and 450 g of IPA.

### Characteristics of Electrode Substrate

With respect to the electrode substrates of the single cells fabricated according to Examples 1 to 13, macropores, the average diameter of the macropores, porosity, and the content of an electrically conductive polymer were measured. The electrode substrate of a single cell fabricated according to Example 1 has an average pore diameter of macropores (A) of 2.5 μm and an average pore diameter of micropores (a) of 0.1 μm, porosity of 78%, and the electrically conductive polymer of 15 wt % based on the total weight of the electrode substrate.

Also, with respect to the electrode substrate of the single cells fabricated according to Examples 2 to 13, the average pore diameter of macropores was about 2 μm, and the average pore diameter of micropores was 0.1 μm. The content of an electrically conductive polymer was diverse, being from 10 to 30 wt %.

### Measurement of Output Density

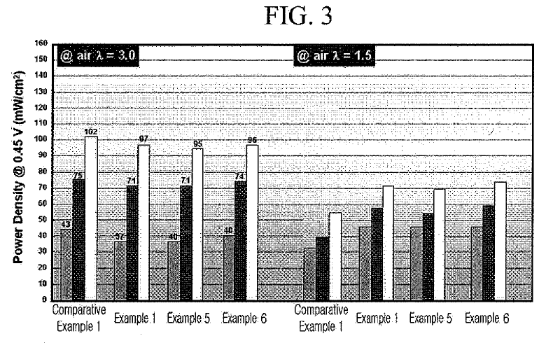

Output densities of the single cells fabricated according to Examples 1 to 13 and Comparative Example 1 were measured at 70° C. while flowing in 1.0M MeOH and changing air flow at 0.45V from 1.5λ(stoichiometry) to 3.0λ. Among them, output density results of the single cells fabricated according to Examples 1, 5, 6 and Comparative Example 1 are presented in FIG. 3.

Referring to FIG. 3, the single cell fabricated according to Example 1 where the polyethyleneterephthalate non-woven fabric was coated with the polyaniline electrically conductive polymer, the single cell fabricated according to Example 5 where the polyester non-woven fabric was coated with the polyaniline electrically conductive polymer, the single cell fabricated according to Example 6 where the polyethyleneterephthalate non-woven fabric with roughness was coated with the polyaniline electrically conductive polymer, and the single cell fabricated according to Comparative Example 1 showed high output density at 3.0λ. However, the single cells fabricated according to Examples 1, 5, and 6 showed a sustained high output density at a low flow of 1.5λ, whereas the single cell of Comparative Example 1 showed drastically deteriorated output density.

Therefore, the electrode substrate fabricated according to the embodiments of the present invention can prevent the output density from deteriorating even though the air influx is low, because it can promote transfer of electrons, reactants, and products.

The foregoing description details certain embodiments of the invention. It will be appreciated, however, that no matter how detailed the foregoing appears in the text, the invention can be practiced in additional ways. It should also be noted that the use of particular terminology when describing certain features or aspects of the invention should not be taken to imply that the terminology is being re-defined herein to be restricted to include any specific characteristics of the features or aspects of the invention with which that terminology is associated. Further, numerous applications are possible for devices of the present disclosure. It will be appreciated by those skilled in the art that various modifications and changes may be made without departing from the scope of the invention. Such modifications and changes are intended to fall within the spirit and scope of the invention, as defined by the appended claims.

What is claimed is:

1. An electrode for a fuel cell, comprising:
an electrode substrate; and
a catalyst layer disposed on one side of the electrode substrate,
wherein the electrode substrate comprises a non-woven fabric coated with an electrically conductive polymer or a woven fabric coated with an electrically conductive polymer.

2. The electrode of claim 1, wherein the electrically conductive polymer is selected from the group consisting of polyaniline, polypyrrol, polyacetylene, polyacene, polythiophene, polyalkylthiophene, poly(p-phenylene), polyphenylene, polyphenylenesulfide, polyphenylenevinylene and polyfuran.

3. The electrode of claim 1, wherein the electrically conductive polymer comprises about 1 to about 30 wt % based on the total weight of the electrode substrate.

4. The electrode of claim 3, wherein the electrically conductive polymer comprises about 5 to about 20 wt % based on the total weight of the electrode substrate.

5. The electrode of claim 1, wherein the non-woven fabric or the woven fabric comprises a material selected from the group consisting of a polymer and glass fiber.

6. The electrode of claim 5, wherein the electrically conductive polymer is selected from the group consisting of a polyolefin-based polymer, a polyester-based polymer, a polysulfone-based polymer, a polyimide-based polymer, a polyetherimide-based polymer, a polyamide-based polymer, polyalkylene and rayon.

7. The electrode of claim 6, wherein the electrically conductive polymer is selected from the group consisting of polyethyleneterephthalate (PET) and polybutyleneterephthalate (PBT).

8. The electrode of claim 1, wherein the electrode substrate includes macropores and micropores, wherein a macropore diameter is “A” and a micropore diameter is “a”, and wherein A−a≦2.5 μm.

9. The electrode of claim 1, wherein the macropores have an average pore diameter ranging from about 0.5 μm to about 3.0 μm.

10. The electrode of claim 9, wherein the macropores have an average pore diameter ranging from about 0.5 μm to about 2.0 μm.

11. The electrode of claim 1, wherein the micropores have an average pore diameter ranging from about 0.01 μm to about 0.5 μm.

12. The electrode of claim 11, wherein the micropores have an average pore diameter ranging from about 0.02 μm to about 0.3 μm.

13. The electrode of claim 1, wherein the electrode substrate has a tensile strength ranging from about 5 kg/mm² to about 50 kg/mm².

14. The electrode of claim 13, wherein the electrode substrate has a tensile strength ranging from about 20 kg/mm² to about 30 kg/mm².

15. The electrode of claim 1, wherein the electrode substrate further comprises a microporous layer, the microporous layer including fluorinated resin or a conductive powder.

16. The electrode of claim 15, wherein the conductive powder is selected from the group consisting of carbon powder, carbon black, acetylene black, activated carbon, carbon fiber, fullerene, carbon nanotubes, carbon nanowire, carbon nanohorns and carbon nanorings.

17. The electrode of claim 15, wherein the fluorinated resin is selected from the group consisting of polyvinylidene fluoride, polytetrafluoroethylene, fluorinated ethylenepropylene, polychlorotrifluoroethylene and fluoroethylene polymer.

18. A membrane-electrode assembly for a fuel cell, comprising:
an anode and a cathode facing each other; and
a polymer electrolyte membrane disposed between the anode and the cathode,
wherein at least one of the anode and the cathode comprises an electrode substrate and a catalyst layer disposed on one side of the electrode substrate, wherein the electrode substrate comprises a non-woven fabric coated with an electrically conductive polymer or a woven fabric coated with an electrically conductive polymer.

19. The membrane-electrode assembly of claim 18, wherein the electrically conductive polymer is selected from the group consisting of polyaniline, polypyrrol, polyacetylene, polyacene, polythiophene, polyalkylthiophene, poly(p-phenylene), polyphenylene, polyphenylenesulfide, polyphenylenevinylene and polyfuran.

20. The membrane-electrode assembly of claim 18, wherein the electrically conductive polymer comprises an amount ranging from about 1 to about 30 wt % based on the total weight of the electrode substrate.

21. The membrane-electrode assembly of claim 20, wherein the electrically conductive polymer comprises an amount ranging from about 5 to about 20 wt % based on the total weight of the electrode substrate.

22. The membrane-electrode assembly of claim 18, wherein the non-woven fabric or the woven fabric comprises a material selected from the group consisting of a polymer and glass fiber.

23. The membrane-electrode assembly of claim 22, wherein the polymer is selected from the group consisting of a polyolefin-based polymer, a polyester-based polymer, a polysulfone-based polymer, a polyimide-based polymer, a polyetherimide-based polymer, a polyamide-based polymer, polyalkylene and rayon.

24. The membrane-electrode assembly of claim 23, wherein the polymer is selected from the group consisting of polyethyleneterephthalate (PET) and polybutyleneterephthalate (PBT).

25. The membrane-electrode assembly of claim 18, wherein the electrode substrate comprises macropores and micropores, wherein a macropore diameter is “A”, wherein a micropore diameter is “a”, and wherein A−a≦2.5 μm.

26. The membrane-electrode assembly of claim 18, wherein the macropores have an average pore diameter ranging from about 0.5 μm to about 3.0 μm.

27. The membrane-electrode assembly of claim 26, wherein the macropores have an average pore diameter ranging from about 0.5 μm to about 2.0 μm.

28. The membrane-electrode assembly of claim 18, wherein the micropores have an average pore diameter ranging from about 0.01 μm to about 0.5 μm.

29. The membrane-electrode assembly of claim 28, wherein the micropores have an average pore diameter ranging from about 0.02 μm to about 0.3 μm.

30. The membrane-electrode assembly of claim 18, wherein the electrode substrate has a tensile strength ranging from about 5 kg/mm² to about 50 kg/mm².

31. The membrane-electrode assembly of claim 30, wherein the electrode substrate has a tensile strength ranging from about 20 kg/mm² to about 30 kg/mm².

32. The membrane-electrode assembly of claim 18, wherein the electrode substrate further comprises a microporous layer, the microporous layer including fluorinated resin or a conductive powder.

33. The membrane-electrode assembly of claim 32, wherein the conductive powder is selected from the group consisting of carbon powder, carbon black, acetylene black, activated carbon, carbon fiber, fullerene, carbon nanotubes, carbon nanowire, carbon nanohorns and carbon nanorings.

34. The membrane-electrode assembly of claim 32, wherein the fluorinated resin is selected from the group consisting of polyvinylidene fluoride, polytetrafluoroethylene, fluorinated ethylenepropylene, polychlorotrifluoroethylene and a fluoroethylene polymer.

35. A fuel cell system, comprising:
an electricity generating element comprising a membrane-electrode assembly, the membrane-electrode assembly comprising an anode and a cathode disposed opposite to each other, a polymer electrolyte membrane, and separators, wherein the electricity generating element is configured to generate electricity based on oxidation of a fuel and reduction of an oxidant;
a fuel supplier configured to supply the fuel to the electricity generating element; and
an oxidant supplier configured to supply the oxidant to the electricity generating element,
wherein at least one of the anode and the cathode comprises an electrode substrate and a catalyst layer disposed on one side of the electrode substrate, and wherein the electrode substrate comprises a non-woven fabric coated with an electrically conductive polymer and a woven fabric coated with an electrically conductive polymer.

36. The fuel cell system of claim 35, wherein the electrically conductive polymer is selected from the group consisting of polyaniline, polypyrrol, polyacetylene, polyacene, polythiophene, polyalkylthiophene, poly(p-phenylene), polyphenylene, polyphenylenesulfide, polyphenylenevinylene and polyfuran.

37. The fuel cell system of claim 35, wherein the electrically conductive polymer comprises an amount of about 1 to about 30 wt % based on the total weight of the electrode substrate.

38. The fuel cell system of claim 37, wherein the electrically conductive polymer comprises an amount of about 5 to about 20 wt % based on the total weight of the electrode substrate.

39. The fuel cell system of claim 35, wherein the non-woven fabric or the woven fabric comprise a material selected from the group consisting of a polymer and glass fiber.

40. The fuel cell system of claim 39, wherein the polymer is selected from the group consisting of a polyolefin-based polymer, a polyester-based polymer, a polysulfone-based polymer, a polyimide-based polymer, a polyetherimide-based polymer, a polyamide-based polymer, polyalkylene and rayon.

41. The fuel cell system of claim 40, wherein the polymer is selected from the group consisting of polyethyleneterephthalate (PET) and polybutyleneterephthalate (PBT).

42. The fuel cell system of claim 35, wherein the electrode substrate includes macropores and micropores, wherein a macropore diameter is “A”, wherein a micropore diameter is “a”, and wherein A−a≦2.5 μm.

43. The fuel cell system of claim 35, wherein the macropores have an average pore diameter ranging from about 0.5 μm to about 3.0 μm.

44. The fuel cell system of claim 43, wherein the macropores have an average pore diameter ranging from about 0.5 μm to about 2.0 μm.

45. The membrane-electrode assembly of claim 35, wherein the micropores have an average pore diameter ranging from about 0.01 μm to about 0.5 μm.

46. The membrane-electrode assembly of claim 45, wherein the micropores have an average pore diameter ranging from about 0.02 μm to about 0.3 μm.

47. The membrane-electrode assembly of claim 35, wherein the electrode substrate has a tensile strength ranging from about 5 kg/mm² to about 50 kg/mm².

48. The membrane-electrode assembly of claim 47, wherein the electrode substrate has a tensile strength ranging from about 20 kg/mm² to about 30 kg/mm².

49. The membrane-electrode assembly of claim 35, wherein the electrode substrate further comprises a microporous layer, the microporous layer including a fluorinated resin or a conductive powder.

50. The membrane-electrode assembly of claim 49, wherein the conductive powder is selected from the group consisting of carbon powder, carbon black, acetylene black, activated carbon, carbon fiber, fullerene, carbon nanotubes, carbon nanowire, carbon nanohorns and carbon nanorings.

51. The membrane-electrode assembly of claim 49, wherein the fluorinated resin is selected from the group consisting of polyvinylidene fluoride, polytetrafluoroethylene, fluorinated ethylenepropylene, polychlorotrifluoroethylene and fluoroethylene polymer.
